(19) United States
(12) Patent Application Publication
(10) Pub. No.: US 2011/0022794 A1
(43) Pub. Date: Jan. 27, 2011

(54) DISTRIBUTED CACHE SYSTEM IN A DRIVE ARRAY

(76) Inventors: Mahmoud K. Jibbe, Wichita, KS (US); Senthil Kannan, RediyarPalayam (IN)

Correspondence Address: CHRISTOPHER P MAIORANA, PC;LSI Corporation, 24840 HARPER, SUITE 100, ST CLAIR SHORES, MI, 48080, US

(21) Appl. No.: 12/898,905

(22) Filed: Oct. 6, 2010

Related U.S. Application Data
(63) Continuation of application No. PCT/US2008/006402, filed on May 19, 2008.
(60) Provisional application No. 61/046,815, filed on Apr. 22, 2008.

(51) Int. Cl. G06F 12/08; G06F 12/00

(52) U.S. Cl. 711/113; 711/E12.001; 711/E12.019

(57) ABSTRACT

An apparatus comprising a drive array, a first cache circuit, a plurality of second cache circuits and a controller. The drive array may comprise a plurality of disk drives. The plurality of second cache circuits may each be connected to a respective one of the disk drives. The controller may be configured to (i) control read and write operations of the disk drives, (ii) read and write information from the disk drives to the first cache, (iii) read and write information to the second cache circuits, and (iv) control reading and writing of information directly from one of the disk drives to one of the second cache circuits.

This is a continuation of International Application PCT/US2008/006402, with an International Filing Date of May 19, 2008, which claims priority to U.S. Provisional Application No. 61/046,815, filed Apr. 22, 2008, each of which is incorporated by reference.

### FIELD OF THE INVENTION

The present invention relates to drive arrays generally and, more particularly, to a method and/or apparatus for implementing a distributed cache system in a drive array.

### BACKGROUND OF THE INVENTION

Conventional external Redundant Array of Independent Disks (RAID) controllers have a fixed local cache (RAM) used by all volumes. Based on frequent block address patterns observed, the RAID controller pre-fetches the related data from corresponding block address in advance. The approach of block-caching may not satisfy the growing access density requirement of applications (such as messaging, Web servers and Database applications) where a small percentage of files contribute to major percentage of I/O requests. This can cause latency and access-time delays.

The cache in a conventional RAID Controller has a limited capacity. A conventional cache may not be able to satisfy the growing access density requirements of modern arrays. The cache in a conventional RAID controller uses block-caching which may not meet the demand of high I/O intensive application demanding file-caching. Other issues with growing data volumes in the Storage Area Network (SAN), environment arise when the limited RAID cache capacity does not meet the cache demand. All the Logical Unit Number devices (LUNs) are using the common RAID level block-caching. Such a configuration often causes a bottle neck when trying to serve different operating systems and applications residing data from different LUNs.

### SUMMARY OF THE INVENTION

The present invention concerns an apparatus comprising a drive array, a first cache circuit, a plurality of second cache circuits and a controller. The drive array may comprise a plurality of disk drives. The plurality of second cache circuits may each be connected to a respective one of the disk drives. The controller may be configured to (i) control read and write operations of the disk drives, (ii) read and write information from the disk drives to the first cache, (iii) read and write information to the second cache circuits, and (iv) control reading and writing of information directly from one of the disk drives to one of the second cache circuits.

The objects, features and advantages of the present invention include implementing a distributed cache that may (i) allow file-caching in the same subsystem as the storage array, (ii) provide file-caching to be dedicated to the volumes or LUNs, (iii) provide file-caching distributed across a group of SSD that may be scaled, (iv) provide unlimited cache capacity for RAID caching, (v) reduce the access-time, (vi) increase access-density, and/or (vii) boost overall array performance.

### BRIEF DESCRIPTION OF THE DRAWINGS

These and other objects, features and advantages of the present invention will be apparent from the following detailed description and the appended claims and drawings in which:

FIG. 1 is a block diagram of a system of the present invention;

FIG. 2 is a flow diagram illustrating the operation of the present invention;

FIG. 3 is a block diagram of an alternate implementation of the group is shown; and

FIG. 4 is a block diagram of another alternate implementation of the cache group is shown.

### DETAILED DESCRIPTION OF THE PREFERRED EMBODIMENTS

The present invention may implement an Redundant Array of Independent Disks (RAID) controller. The controller may be implemented externally to the drives. The controller may be designed to have access to a cache-syndicate (or group of cache portions). The cache syndicate may be considered a logical group of cache memories that may reside on a solid state device (SSD). The volumes owned (or controlled) by the RAID controller may be assigned a dedicated cache-repository from the cache-syndicate. The particular assigned cache-repository may be projected to the operating system/application layer for file-caching.

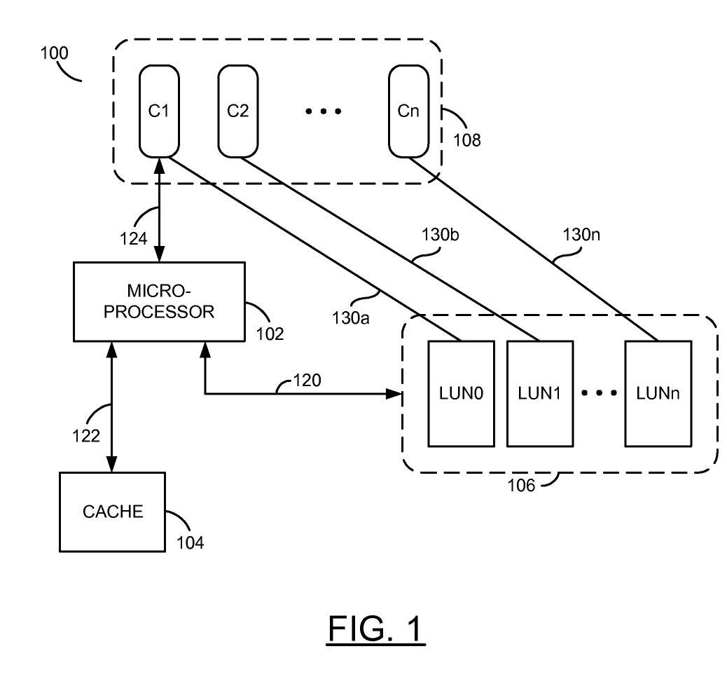

Referring to FIG. 1, a block diagram of a system 100 is shown. The system 100 may be implemented in a RAID environment. The system 100 generally comprises a block (or circuit) 102, a block (or circuit) 104, a block (or circuit) 106, and a block (or circuit) 108. The circuit 102 may be implemented as a microprocessor (or a portion of a micro-controller). The circuit 104 may be implemented as a local cache. The circuit 106 may be implemented as a storage circuit. The circuit 108 may be implemented as a cache group (or cache syndicate). The circuit 106 generally comprises a number of volumes LUN0-LUNn. The number of volumes LUN0-LUNn may be varied to meet the design criteria of a particular implementation.

The cache group 108 generally comprises a number of cache sections C1-Cn. The cache group 108 may be considered a cache repository. The cache sections C1-Cn may be implemented on a Solid State Device (SSD) group. For example, the cache sections C1-Cn may be implemented on a solid state memory device. Examples of solid state memory devices that may be implemented include a Dual Inline Memory Module (DIMM), a nano flash memory, or other volatile or non-volatile memory. The number of cache sections C1-Cn may be varied to meet the design criteria of a particular implementation. In one example, the number of volumes LUN0-LUNn may be configured to match the number of cache sections C1-Cn. However, other ratios (e.g., two or more cache sections C1-Cn for each volume LUN0-LUNn) may also be implemented. In one example, the cache group 108 may be implemented and/or fabricated as an external chip from the circuit 102. In another example, the cache group 106 may be implemented and/or fabricated as part of the circuit 102. If the circuit 106 is implemented as part of the circuit 102, then separate memory ports may be implemented to allow simultaneous access to each of the cache sections C1-Cn.

The controller circuit 102 may be connected to the circuit 106 through a bus 120. The bus 120 may be used to control read and write operations of the volumes LUN0-LUNn. In one example, the bus 120 may be implemented as a bi-directional bus. In another example, the bus 120 may be implemented as one or more uni-directional busses. The bit width of the bus 120 may be varied to meet the design criteria of a particular implementation.

The controller circuit 102 may be connected to the circuit 104 through a bus 122. The bus 122 may be used to control sending read and write information from the volumes LUN0-LUNn to the circuit 104. In one example, the bus 122 may be implemented as a bi-directional bus. In another example, the bus 122 may be implemented as one or more uni-directional busses. The bit width of the bus 122 may be varied to meet the design criteria of a particular implementation.

The controller circuit 102 may be connected to the circuit 108 through a bus 124. The bus 124 may be used to control reading and writing of information from the volumes LUN0-LUNn to the circuit 108. In one example, the bus 124 may be implemented as a bi-directional bus. In another example, the bus 124 may be implemented as one or more uni-directional busses. The bit width of the bus 124 may be varied to meet the design criteria of a particular implementation.

The circuit 106 may be connected to the circuit 108 through a plurality of connection busses 130a-130n. The controller circuit 102 may control sending information directly from the volumes LUN0-LUNn to the cache group 108 (e.g., LUN0 to C1, LUN1 to C2, LUNn—Cn, etc.) In one example, the connection busses 130a-130n may be implemented as a plurality of bi-directional busses. In another example, the connection busses 130a-130n may be implemented as a plurality of uni-directional busses. The bit width of the connection busses 130a-130n may be varied to meet the design criteria of a particular implementation.

The system 100 may implement the cache portions C1-Cn as a group of solid state devices to for a cache-syndicate. When the system 100 creates a new one of the volumes LUN0-LUNn, a corresponding cache portion C1-Cn is normally created in the circuit 108. The capacity of the circuit 108 is normally decided as part of a pre-defined controller specification. For example, the capacity of the circuit 108 may be defined as being, in one example, as being between 1% and 10% of the capacity of the volumes LUN0-LUNn. However, other percentages may be implemented to meet the design criteria of a particular implementation. The particular cache portion C1-Cn may become a dedicated cache resource for the particular volume LUN0-LUNn. The system 100 may initialize the particular volume LUN0-LUNn and the particular cache portion C1-Cn in such a way that an operating system and/or application program may use the cache portion C1-Cn for file-caching and/or additional volume capacity for storing actual data.

The system 100 may be implemented with n number of volumes, where n is an integer. By implementing the volumes LUN0-LUNn each having one or more cache sections C1-Cn created, the system 100 may provide an increase in performance. Operating system and/or application programs may have access to the combined space of the volumes LUN0-LUNn cache-repository sections C1-Cn. In one example, the cache sections C1-Cn may be implemented in addition to the local cache circuit 104. However, in certain design implementations, the cache sections C1-Cn may be implemented in place of the local cache circuit 104.

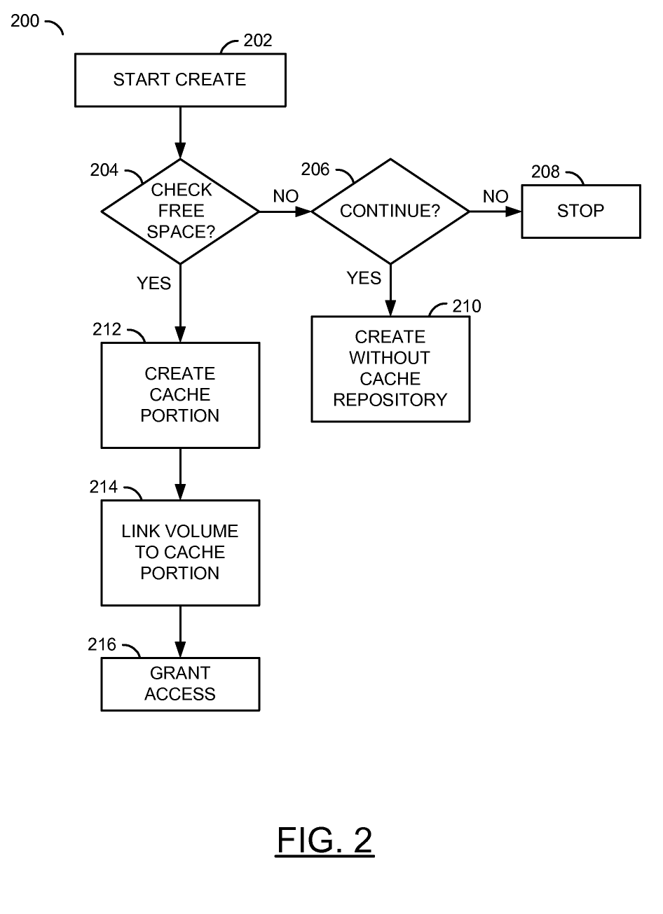

Referring to FIG. 2, a flow diagram of a method (or process) 200 is shown. The process 200 may comprise a state (or step) 202, a decision state (or step) 204, a decision state (or step) 206, a state (or step) 208, a state (or step) 210, a state 212 (or step), a state (or step) 214, and a state (or step) 216.

The state 202 may create one of the volumes LUN0-LUNn. For example, the state 202 may initiate a create volume sequence to begin the creation of a particular volume (e.g., the volume LUN0). The decision state 204 may determine if enough free space is available in the circuit 108 to add one of the cache portions C1-Cn. For example, the decision state 204 may determine if there is enough space to add the cache portion C1. If not, the process 200 moves to the decision state 206. The decision state 206 may determine if a user wants to create the volume without the cache portion C1. If so, then the process 200 may move to the state 210. The state 210 creates the volume LUN0 without the corresponding cache portion C1. If not, the process 200 moves to the state 208. The state 208 stops the creation of the volume LUN0. If there is free space in the circuit 108, then the process 200 moves to the state 212. The state 212 creates the cache portion C1 and the volume LUN0. The state 214 may link the volume LUN0 to the corresponding cache portion Cn. The state 216 may allow access to the volume LUN0 plus the space in the cache portion Cn by the operating system and/or application programs.

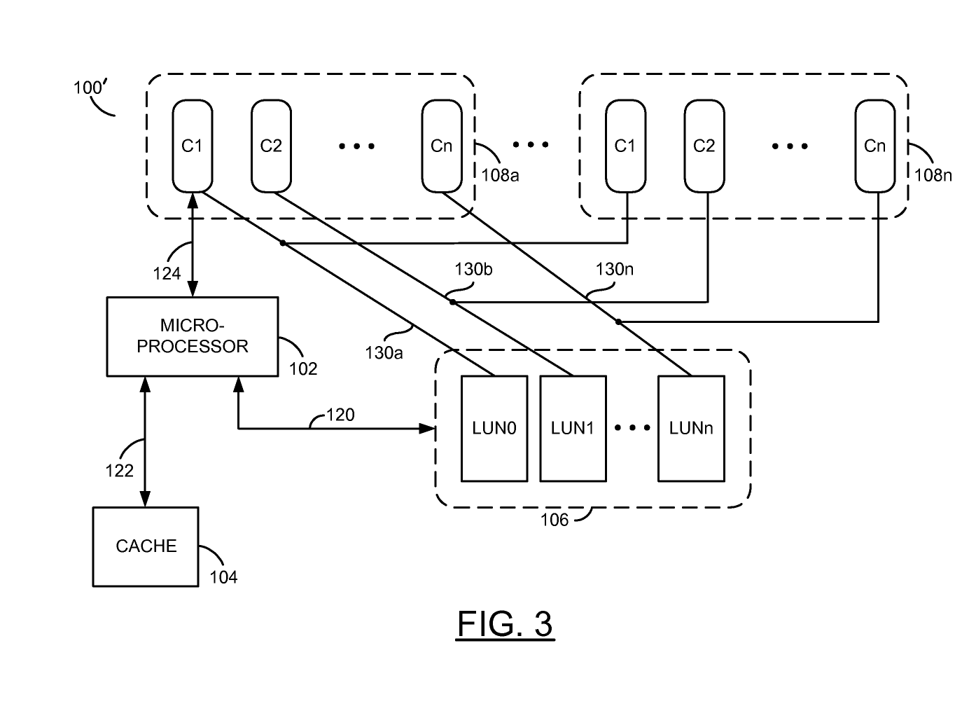

Referring to FIG. 3, an alternate implementation of a system 100′ is shown. The system 100′ may implement a number of cache sections 108a-108n. In one example, each of the cache sections 108a-108n may be implemented as a separate device. In another example, each of the cache sections 108a-108n may be implemented on a separate portions of the same device. If the cache portions 108a-108n are implemented on separate devices, in-service repairs of the system 100′ may be implemented. For example, one of the cache section 108a-108n may be replaced, while the other cache sections 108a-108n may remain in service. In one example, the cache portion C1 of the cache portion 108a and the cache portion C1 of the cache portion 108n are shown linked to the volume LUN0. By linking more than one of the cache portions C1-Cn of each of two or more of the cache portions 108a-108n to a corresponding volume LUN0-LUNn, a cache redundancy may be implemented. While the cache portion C1 are shown linked to the volume LUN0, the particular cache portions C1-Cn linked to each of the volumes LUN0-LUNn may be varied to meet the design criteria of a particular implementation.

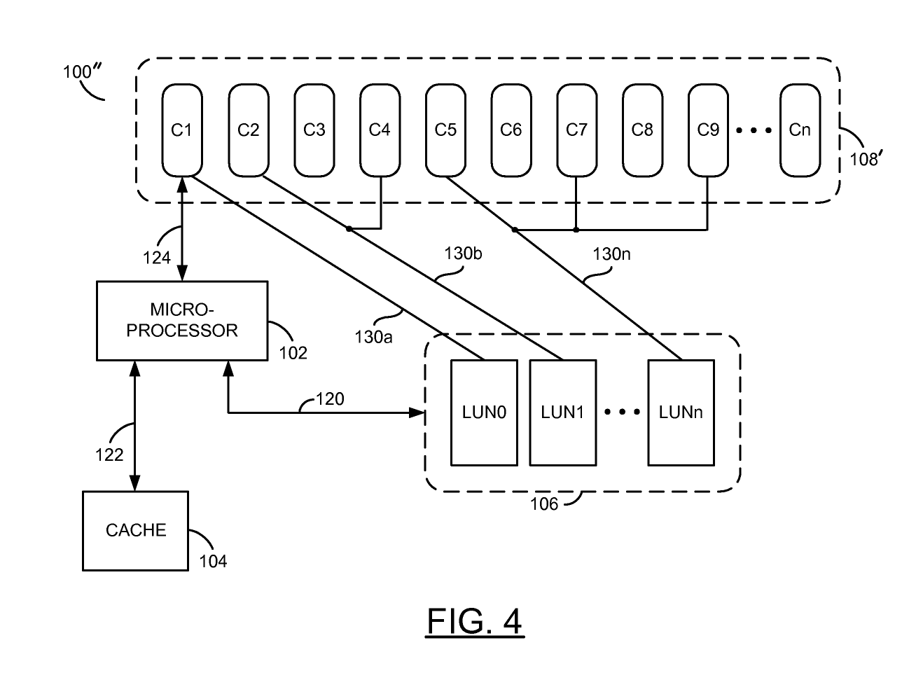

Referring to FIG. 4, an alternate implementation of a system 100″ is shown. The system 100″ may implement a circuit 108′ as a cache pool. The circuit 108′ may implement a number of cache section C1-Cn that is greater than the number of volumes LUN0-LUNn. More than one of the cache portions C1-Cn may be linked to each of the volumes LUN0-LUNn. For example, the volume LUN1 is show linked to the cache portion C2 and the cache portion C4. The volume LUNn is shown linked to the cache portion C5, the cache portion C7 and the cache portion C9. The particular cache portions C1-Cn linked to each of the volumes LUN0-LUN1 may be varied to meet the design criteria of a particular implementation. The cache portions C1-Cn may be implemented having the same size or different sizes. If the cache portions C1-Cn are implemented having the same size, then assigning more than one of the cache portions C1-Cn to a single one of the volumes LUN0-LUNn may allow additional caching on the volumes LUN0-LUN1 that experience a higher load. The cache portions C1-Cn may be dynamically allocated to the volumes LUN0-LUN1 in response to the volume of I/O requests received. For example, the configurations of the cache portions C1-Cn may be reconfigured one or more times after an initial configuration.

In general, the system 100′ of FIG. 3 implements a number of cache sections 108a-108n. The system 100″ of FIG. 4 implements a larger cache section 108′ when compared to the cache section 108 of FIG. 1. Combinations of the system 100′ and 100″ may be implemented. For example, each of the cache circuits 108a-108n of FIG. 3 may be implemented with the larger cache circuit 108′ of FIG. 4. By implementing a number of the circuits 108′, the system 100″ may implement redundancy. Other combinations of the system 100, the system 100′ and the system 100″ may be implemented.

The file-caching circuit 108 of the system 100 is normally made available in the same subsystem as the storage array 106. The file-caching may be dedicated to particular volumes LUN0-LUNn. In one example, the file-caching circuit 108 may be distributed across a group of solid state devices. Such solid state devices may be scaled.

The system 100 may provide an unlimited and/or expandable capacity of the circuit 108 that may be dedicated to caching particular volumes LUN0-LUNn. By implementing the cache circuit 108 as a solid state device, the overall access time of particular cache reads may be reduced. The reduced access time may occur while the overall access-density increases. The cache circuit 108 may increase the overall performance of the volumes LUN0-LUNn.

The cache group 108 may be implemented using a solid state memory device that only adds slightly to the overall cost to manufacture the system 100. In certain implementations, the cache group 108 may be mirrored to provide redundancy in case of a data failure. The system may be useful in an enterprise level Storage Area Network (SAN) environment where multiple operating systems and/or multiple users using different applications may need access to the array 106. For example, messaging, web and/or database server applications may implement the system 100.

The function performed by the flow diagram of FIG. 2 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMs, RAMs, EPROMs, EEPROMs, Flash memory, magnetic or optical cards, or any type of media suitable for storing electronic instructions.

As used herein, the term “simultaneous” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the scope of the invention.

1. An apparatus comprising:
a drive array comprising a plurality of disk drives;
a first cache circuit;
a plurality of second cache circuits each connected to a respective one of said disk drives; and
a controller configured to (i) control read and write operations of said disk drives, (ii) read and write information from said disk drives to said first cache, (iii) read and write information to said second cache circuits, and (iv) control reading and writing of information directly from one of said disk drives to one of said second cache circuits.

2. The apparatus according to claim 1, wherein said controller comprises a microprocessor.

3. The apparatus according to claim 1, wherein said controller controls the read and write operations of said disk drives through a first control bus connected between said controller and said disk drives.

4. The apparatus according to claim 3, wherein said controller controls sending the read and write information from said disk drives to said first cache through a second control bus.

5. The apparatus according to claim 4, wherein said controller controls sending information from said disk drives to said second cache circuits through a third control bus.

6. The apparatus according to claim 5, wherein (i) said controller controls sending information directly from said disk drives to said second cache circuits through said second control bus and (ii) said information sent directly to said second cache circuits is sent over a plurality of connection busses.

7. The apparatus according to claim 5, wherein said first bus, said second bus and said third bus each comprise bi-directional busses.

8. The apparatus according to claim 1, wherein said plurality of second cache circuits are implemented as solid state memory devices.

9. The apparatus according to claim 1, wherein (i) said controller controls sending information directly from said disk drives to said second cache circuits through a control bus and (ii) said information sent directly to said second cache circuits is sent over a plurality of connection busses.

10. The apparatus according to claim 1, wherein (i) a first one or more of said plurality of second cache circuits are implemented on a first memory circuit and (ii) a second one or more of said plurality of second cache circuits are implemented on a second memory circuit.

11. The apparatus according to claim 1, wherein (i) a first one or more of said plurality of second cache circuits are implemented on a first portion of a memory circuit and (ii) a second one or more of said plurality of second cache circuits are implemented on a second portion of said memory circuit.

12. The apparatus according to claim 11, wherein a plurality of said second cache circuits are configured to be linked to one of said disk drives.

13. The apparatus according to claim 12, wherein said plurality of second cache circuits are dynamically allocated to said disk drives.

14. The apparatus according to claim 13, wherein said plurality of second cache circuits are reconfigurable in response to input/output requests to said disk drives.

15. The apparatus according to claim 1, wherein each of said disk drives comprises a data volume.

16. The apparatus according to claim 1, wherein two or more of said disk drives comprises a data volume.

17. An apparatus comprising:
means for implementing a drive array comprising a plurality of disk drives;
means for implementing a first cache circuit;
means for implementing a plurality of second cache circuits each connected to a respective one of said disk drives; and
means for (i) controlling read and write operations of said disk drives, (ii) reading and writing information from said disk drives to said first cache, (iii) reading and writing information to said second cache circuits, and (iv) controlling the reading and writing of information directly from one of said disk drives to one of said second cache circuits.

18. A method for configuring a drive controller in a drive array, comprising the steps of:
(A) initiating the creation of a drive volume from one of a plurality of disk drives;
(B) activating one of a plurality of cache portions;
(C) linking said activated cache portion to said drive volume; and
(D) granting access to said drive volume.

19. The method according to claim 18, further comprising the steps of:
prior to step (B), checking whether space is available for said one of said plurality of cache portions;
if said space is available, continuing to step (B); and
if said space is not available, skipping step (C) and continuing to step (D).
